(19) United States
(12) Patent Application Publication
(10) Pub. No.: US 2017/0255342 A1
(43) Pub. Date: Sep. 7, 2017

(54) MOBILE ICON-CENTRIC ENTERPRISE CONTENT MANAGEMENT PLATFORM

(71) Applicant: Glaswegian Enterprises Inc., Coquitlam (CA)

(72) Inventors: Bruno Fontaine, Coquitlam (CA); Jim Orr, Coquitlam (CA)

(73) Assignee: Glaswegian Enterprises Inc., Coquitlam, BC (CA)

(21) Appl. No.: 14/912,990

(22) PCT Filed: Mar. 30, 2015
(86) PCT No.: PCT/CA2015/050247

§ 371 Date: Feb. 19, 2016

(51) Int. Cl. G06F 3/0482; G06Q 10/10; G06F 3/0484; G06F 17/30; G06F 3/0481; G06T 11/60

(52) U.S. Cl. CPC G06F 3/0482; G06F 3/04817; G06T 11/60; G06F 3/04847; G06F 17/30905; G06Q 10/10; G06T 2200/24

(57) ABSTRACT

An icon-centric enterprise management system comprises a presentation environment characterized by user-defined icons that include menu icons, action icons and icons that reveal content. Icons are designed by the user and are inserted into the system hierarchy by means of an insertion-enabling icon that is revealed only to users authorized to modify the hierarchy. An instance management database enables the handling of different organizational customers' instances of enterprise content and individual instances databases and instances file repositories comprise the icon records of the design and user-defined functionality for the various icons in the hierarchy.

### CROSS-REFERENCE TO RELATED APPLICATIONS

This application claims priority from PCT Patent Application No. PCT/CA2015/050247 filed Mar. 30, 2015.

### FIELD OF THE INVENTION

This invention relates to a system for the delivery and management of enterprise content. In particular the invention relates to an icon-centric Enterprise Content Management presentation environment, in which features of the system are determined or characterized by operations on icons that represent action or content items.

### BACKGROUND OF THE INVENTION

Enterprise Content Management (“ECM”) systems provide a consistent platform for users to access content in an enterprise.

Documentum from EMC Corporation is an ECM system, available for mobiles, that operates using a series of windows, some with a classic Windows-style directory or content listings, sometimes with previews or thumbnails and context menus and drop-down menus. Documentum uses the concept of a “workspace” for accessing content items by functional or other categories.

Alfresco One, offered by Alfresco Software, Inc., uses the idea of “sites” (analogous to workspaces) and relies on the use of a dashboard. In order to access content items, one clicks on a drop-down menu, selects “library” and then sees a list of documents.

IBM's Content Navigator uses depictions of folders in a list on one side of the window, an adjacent set of contents of a folder and another adjacent thumbnail. The content may be selectively viewed as icons or as a film strip with the ability to open and scroll through individual content items. Each icon includes a comments section to collect comments associated with a document. Higher lever folders may be used to designate a business process or a department, while sub-folders may be organized by type of document. It allows for “teamspaces” for collaborative workflows.

Fasoo (Fasoo.com, Inc.) offers a rights management protocol for ECM systems. It provides encryption of content items such that only authorized users may view the content, or take specified actions in relation to the content item, depending on the access privileges of each user.

U.S. Pat. No. 8,892,679, owned by Box, Inc. is entitled “Mobile device, methods and user interfaces thereof in a mobile device platform featuring multifunctional access and engagement in a collaborative environment provided by a cloud-based platform”. It discloses a mobile-enabled interface designed to allow server-based collaboration among the multiple users and collaborators in an enterprise as well as enable utilization of multimedia and multifunctional content in a shared space among multiple users. Updates are received regarding activities performed by a user and one or more collaborators on contents in a workspace. There is displayed, on an interactive user interface, lists of information based on the updates to facilitate interaction from the user with respect to the updates. An example of the lists of information can include an activity and, if one or more files are associated with the activity, thumbnails that represent previews of the one or more files. The thumbnails can enable the user to interact with the files and/or the collaborators.

U.S. Pat. No. 8,880,461, owned by Open Text is entitled “Method and system for managing enterprise content”. The system delivers documents and data content across different organizational units of an enterprise, which may originate from different enterprise systems and data stores by creating a share document view. Content is organized in a format that enables a user to relate the content to the workflow that they are part of. A given document or group of documents may be analyzed using tools. The system includes a network service that enables a configuration utility to automatically discover the objects and metadata and provides for a mapping of selected fields of the metadata to regions displayed in the user interface view with provision for filtering the data by mapping selected fields to a user input form. The objective is to allow a business analyst to create solutions without writing and maintaining complex program logic for each combination of presentation environment, enterprise system and data store.

It is an object of this invention to provide an enterprise content management system and presentation environment that is particularly easy to use and manage.

Features of the system of the invention include an icon-centric organizational hierarchy, user-created icons, icon functions and features that are defined upon icon assignment by the user and user access privileges that are associated with security levels assigned to icons.

These and other objects and features of the invention will be better understood by reference to the detailed description of the preferred embodiment that follows. Note that the objects referred to above are statements of what motivated the invention rather than promises. Not all of the objects are necessarily met by all embodiments of the invention described below or by the invention defined by each of the claims.

### SUMMARY OF THE INVENTION

The ECM system of the invention is a hierarchical, icon-based menu system for organizing an enterprise's information and applications and is delivered by a server under an SAAS model. The system is ideally suited for use by thin clients, enabling its use on mobile devices.

The presentation environment is characterized by rows of icons, preferably having similar form factors and common design features. Users select icons to either display content, or to navigate through the hierarchy of information, depending on the type of icon that is selected. Icons may represent individual multimedia content items (such as documents, audio-visual files, spreadsheets, etc.), applications that are opened and run when the icon is selected, links to web pages, a blog-like storage facility or menu icons that reveal others icons when selected.

The system uses a single tree-based hierarchical menu structure for all users in an enterprise so that all users in a given enterprise access a single unitary enterprise database of content. Selecting an icon that is a menu type of icon causes the current display of icons to be replaced with a display of the collection of icons that the menu icon represented. A user can thereby drill down through the hierarchy of information or operations by selecting icons. A hierarchy tracking display allows the user to determine the location within the hierarchy that the current icon view represents.

A design icon is selected to enable the user to easily design the look of an icon for immediate or later assignment in the hierarchy. The design process allows the user to select a background and a foreground images that are combined and to adjust the position and size of the foreground image on the background. Where a user uploads one of the component images for use in icon creation, the component images may be resized to fit the maximum size allowed. Appropriate records are maintained to enable the use and editing of the icons.

Users assign functionality to the icons by selecting among types offered by the server or the system application and the users provide additional inputs as prompted by the system application in order to render the icon fully functional according to the selected type. The assignment of functionality also includes the user-directed assignment of an icon access security level for each new icon, thereby directly controlling access to the icon by other users.

Icons are positioned in the desired location within the hierarchy by making available, at each branch of the hierarchy, an insertion icon that when selected enables the user to retrieve existing icons from a repository maintained by the system for insertion into the same branch and to assign functionality to the icon. Such capacity to insert new icons into the hierarchy is controlled by assigning access privileges to the insertion icon such that it is only revealed to users authorized to modify the hierarchy.

The system is enabled by maintaining a database and file repository associated with each customer. The content to be revealed and the hierarchy that are established and maintained by a given organizational customer are determined by the icon characteristics, which are recorded in the database and file repository for that given customer, collectively referred to as an “instance”.

Separate instances may be supported by the server for multiple organizational customers by means of a global database and file repository for use across instances, along with instance-specific databases and repositories which are queried when serving a particular customer.

The instance-specific databases and file repositories include records associating users with different offices/locations of an instance, and icon records detailing the types of icons, the icon image, characterizing each icon's functionality, associating multimedia content as appropriate, or associating the icon with child icons (in the case of menu icons), among other icon-specific information.

The system is delivered with customization tools such that the user can easily implement a user-driven hierarchy, can design and create icons for use in the system, and can assign access privileges to each icon according to icon access security levels associated with each icon. The system also allows a user to create banners and backgrounds to customize the look and feel of the interface.

Depending on the access privileges for a given user of an instance, the server will deliver a display of each branch of the hierarchy that reveals only those icons having an icon access security level corresponding to that of the particular user or at a lower access security level than that of the user. A group/location access security level may also be used to further limit access according to the location or group within an organization that the particular user is associated with.

Aspects of the invention include the server-based systems, processes, databases, records and file repositories used to implement the icon-centric ECM and to manage the various instances that are supported by the server for various customers.

The invention comprises the methods embodied in the system and the system and computer readable media that enable the methods.

In one aspect, the invention is a method of delivering enterprise content for display on a client device. The method involves maintaining, at a database and a file repository associated with a server, records and files that represent a tree-based hierarchy of icons, the hierarchy comprising a plurality of branches. Each of the icons is associated with one of a plurality of icon-dependent actions. Remote access to the icons is enabled by causing a remote user to navigate the hierarchy by selecting an icon in a given branch and either the server or a system application associated with the server executes an action responsive to the user selecting an icon. The icons as a whole are multifunctional in that a plurality of possible actions are enabled by the icons in the hierarchy. At least one of the icons is a menu icon that reveals one or more other icons at a lower branch of the hierarchy. At least one other icon is a content icon that, when selected by a user, causes the display of a document on the remote device or the running of an audio or a video file for delivery to the remote device. At least one of the other icons causes either the launch of an application or the display of a web page identified by a hyperlink. Authorized users create icons by means of the display to an authorized user on the device of an icon that, when selected causes the server to display an interface enabling the authorized user to create and design a new icon an image of which is saved in the file repository and the features of which are recorded in the database. The server displays to authorized users an “insertion icon” on each branch of the hierarchy. Selection by the user of the insertion icon causes the server to display an interface enabling the authorized user to assign functionality to a pre-existing icon and to insert the pre-existing icon with such user-assigned functionality in the branch from which the insertion icon was selected.

In another aspect, the invention is a method of delivering enterprise content for display on a remote client device, comprising maintaining, at a database and a file repository associated with a server, records and files that represent a plurality of icons in a tree-based hierarchy of icons. The hierarchy comprises a plurality of branches. Each of the icons, when selected by a user, causes one of a plurality of icon-dependent actions to occur on the remote device. At least a “menu icon”, when selected by a user, acts to reveal one or more other icons at a lower branch of the hierarchy. At least a different “content icon”, when selected by a user, displays a document or runs an audio file or a video file. At least a third type of icon, when selected by a user, executes an action from among the group of actions comprising launching an application, opening a blog, displaying a linked web page. One or more interfaces are provided to an authorized user for enabling the authorized user to create and design icons; and separately, to populate the hierarchy with icons.

The one or more interfaces provided to the authorized user may comprise a “designer icon” which when selected by said authorized user causes the server to provide an interface enabling the authorized user to create and design a new icon.

The method may comprise, separately or in addition, the display of an “insertion icon” to an authorized user at each branch of the hierarchy. When selected by the user from any of the branches, the insertion icon causes the server to provide an interface enabling the user to select a previously created icon and to assign functionality to said previously created icon, and wherein said server or said system application inserts said previously created icon having said assigned functionality into said branch from which said second predetermined icon was selected.

In a further aspect, the method may comprise an interface prompting an authorized user to identify a background for an icon to be created, to identify a foreground image to be overlaid on the background, the server or the system application overlaying the foreground image on the background, saving the resulting image in a file repository and recording the sources for the background and the foreground images. The interface may also enable the authorized user to position the foreground image in relation to the background and to resize the foreground image. The file repository may also comprise a plurality of pre-existing backgrounds and foreground images for selection by the authorized user and the interface may provide to the authorized user the alternative option of uploading background or foreground images from external sources.

In another aspect, the above mentioned step of the user assigning functionality to the icon comprises the steps of selecting, from a list of options in the interface, a type of action that is to result from user selection of the previously created icon in the hierarchy, specifying a specific action that is to result from such user selection and specifying an access security level to be associated with the previously created icon. Preferably the server displays an insertion icon only to authorized users having a predetermined access security level.

In another aspect of the method, the records maintained at the database comprise a first icon record (“icon design record”) for each icon created by an authorized user, the icon design record containing the location in the file repository of the background, the location in the file repository of the foreground image and an icon ID. The records further comprise a second icon record (“icon functionality record”) for each icon in the hierarchy, the icon functionality record containing data characterizing an action to be executed upon user selection of the icon to which the icon functionality record relates.

In another aspect of the method, the records maintained at the database comprise
an icon functionality record for each icon in the hierarchy, the icon functionality record specifying an icon access security level associated with the icon;
a user record for each user, the user record specifying a user access security level;
and wherein each time a menu icon is selected by a user, the user access security level is compared to the icon access security level and only those icons for which the icon access security level is equal or lower than the user access security level are displayed to the user.

In another aspect, of the method, each icon is associated with an icon functionality record comprising a first field indicative of whether the icon is of a type that reveals other icons when selected by a user, and a second field identifying, if applicable, a menu icon from which the icon depends, and upon a user selecting any particular icon in the hierarchy, the system application determining whether the icon is of a type that reveals other icons and if so, polling all icons in the hierarchy to identify those icons for whom the second field identifies the particular icon.

In yet another aspect, the database comprises for each icon in the hierarchy an icon design record and an icon functionality record, the icon functionality record comprising an icon access security level associated with the icon, and for each of a plurality of users, a user record associating each user with a user access security level. Before displaying any particular icon to a given user, the icon access security level for the particular icon is compared to the given user's user access security level, and only those icons are displayed that have an icon access security level equal to or lower than the user access security level associated with the given user. The action that is executed upon the selection of an icon by a particular user may be a function of the user access security level associated with that user.

In another aspect, the plurality of possible actions triggered by the selection of an icon includes the opening of a copy of a blog that can also be opened by another icon at another branch of said hierarchy.

In another aspect, the invention is a method of delivering enterprise content for display on a remote client device. The method comprises maintaining, at one or more databases and one or more file repositories associated with a server, records and files that represent a first plurality of icons in a first tree-based hierarchy of icons (“first hierarchy”), and a second plurality of icons in a second tree-based hierarchy of icons (“second hierarchy”), each of the first hierarchy and the second hierarchy comprising a plurality of branches, maintaining at the one or more databases a user record for each of a plurality of users, the user record containing an association of the user with either the first or second hierarchy, providing access for a given user to the icons in the first or second hierarchy as a function of the association in the given user's user record. Each of the icons, when selected by the given user, causes one of a plurality of icon-dependent actions to occur on a remote device associated with the user. At least a first one of said icons (“menu icon”), when selected by said given user, reveals one or more other icons at a lower branch of the hierarchy identified in the given user's user record. At least a second one of the icons (“content icon”), when selected by a user, displaying a document or running an audio file or a video file. At least a third one of the icons, when selected by a user, executes an action from among the group of actions comprising launching an application, opening a blog, displaying a linked web page. One or more interfaces are provided to an authorized user for enabling the user to create and design icons and populate the icons into the hierarchy with which the authorized user is associated in the user record.

The databases may comprise an instances management database containing an association of domain names with each of the first and second hierarchies. The files may comprise a library of icon backgrounds and icon foregrounds accessible to users associated with the first hierarchy and to users associated with the second hierarchy, and the files may comprise records of icon backgrounds and foregrounds associated with the first hierarchy, said method comprising the step of revealing to a user associated with the first hierarchy only those icons associated with the first hierarchy.

The records may comprise icon creation records each recording a unique icon identifier and the combination of background and foreground that comprise each icon, the records further comprising icon functionality records each determining the behavior of a given icon, the file repositories comprising a first file repository associated with the first hierarchy stores images of icons associated with the first hierarchy and a second file repository associated with the second hierarchy stores images of icons associated with the second hierarchy.

The foregoing may cover only some of the aspects of the invention. Other aspects of the invention may be appreciated by reference to the following description of at least one mode for carrying out the invention in terms of one or more examples. The following mode(s) for carrying out the invention is not a definition of the invention itself, but is only an example that embodies in some way the features of the invention.

### BRIEF DESCRIPTION OF THE DRAWINGS

At least one mode for carrying out the invention in terms of one or more examples will be described by reference to the drawings thereof in which:

FIG. 1 illustrates the server, devices, databases and files repositories of the preferred embodiment of the invention;

FIG. 2 is an exemplary hierarchy of icons for a given organizational customer;

FIG. 3 is an exemplary login screen for a specific organizational customer/instance according to the preferred embodiment;

FIG. 4 is a home page user interface for a specific instance according to the preferred embodiment;

FIG. 4A is an interface display generated when a menu icon is selected from another branch of the hierarchy;

FIG. 5 is an Access Control Loop used by the system application for determining the visibility of icons to a given user;

FIG. 6 is a list of certain data tables maintained in each Instance Database;

FIG. 7 is a list of certain data tables maintained in the Instances Management Database;

FIG. 8 is table of the fields for certain records according to the preferred embodiment; and,

FIG. 9 is a chart of the files repository according to the preferred embodiment.

### DETAILED DESCRIPTION OF AT LEAST ONE MODE FOR CARRYING OUT THE INVENTION IN TERMS OF EXAMPLE(S)

The icon-centric ECM system of the invention is preferably delivered under a SAAS model from a server 10 to thin client devices 12, including mobile devices. Devices 12 require a browser to interact with the server.

Server 10 includes an Instance Access Control subsystem 14, a User Access Control subsystem 16, a System Application 18 and optionally, Custom Modules 20.

The server 10 is associated with an Instances Management Database 22, Instances Databases 24 and a File Server 26 to support, among other things, user-directed icon features and the content to be delivered to users of the system.

Custom Modules 20 are applications that are enabled for a given organizational customer and that may be launched by selecting a particular application icon as will be described below.

Overview

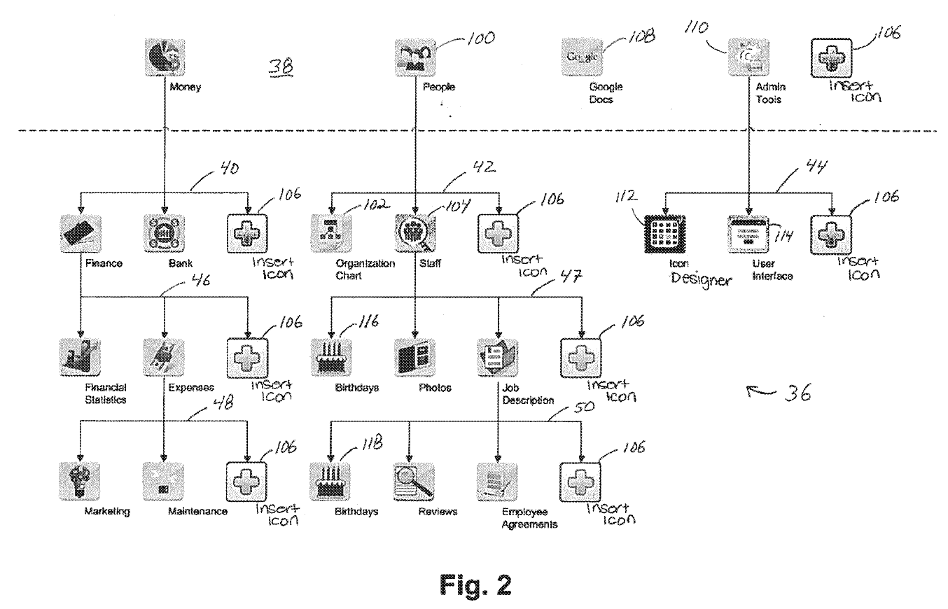

FIG. 2 is a schematic of an exemplary hierarchy 36 for a given organizational customer. Hierarchy 36 comprises a plurality of branches 38, 40, 42, 44, 46, 47, 48, 50.

Each organizational customer determines its own hierarchy of content through the creation of icons, the assignment of their functionality and their insertion into the hierarchy. The creation of a new icon for eventual use in the hierarchy is enabled by providing an icon (Icon Designer 112) that is dedicated to that purpose. In the preferred embodiment, Icon Designer 112 is located at branch 44 under the “parent” icon entitled Administrative Tools 110.

Selecting Icon Designer 112 causes the server 10 to provide to the device 12 an interface by which a user designs and creates a new icon. Once created by a user, an image of the icon is stored in an appropriate client file repository (Client 30 FR, Client 32 FR, etc.) and features of the icon design are stored in an appropriate instance database (Client 30 DB, Client 32 DB, etc.).

The enablement, activation and insertion by a user of an icon into a given branch of the hierarchy is enabled by the system application 18 providing an insertion icon 106 in each branch. However, the insertion icons 106 are made visible only to users who are authorized to modify the hierarchy. In FIG. 2, we have assumed that the user is authorized to modify the hierarchy as a result of which insertion icons 106 are shown as being visible to the user.

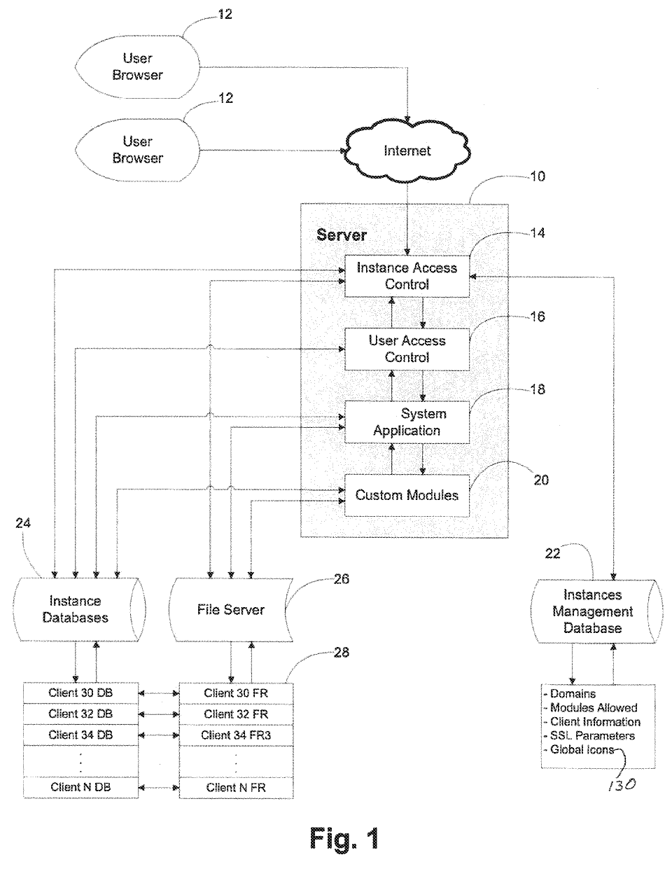

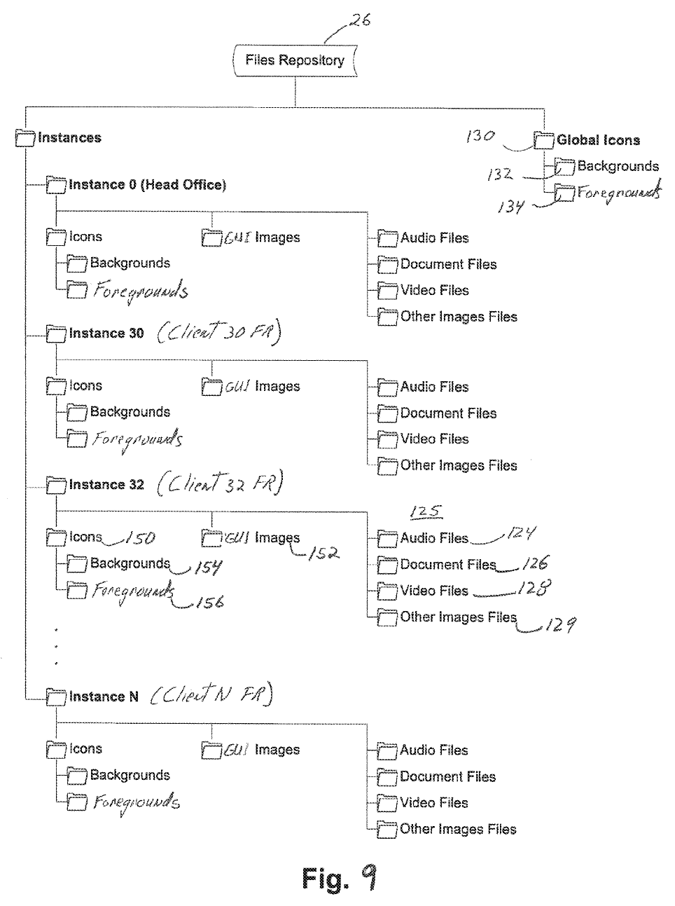

In order to insert an icon into the hierarchy, the user selects an insertion icon (“Insert Icon”) 106 from a given branch in the hierarchy. Selection of the Insert Icon 106 causes the server 10 to deliver an interface to the device 12. From the interface, the user selects either an icon that was previously created by a user for use in that instance (by that organizational customer) or the user selects an icon from a library 130 of icons stored in a file repository 28 (FIGS. 1 and 9). The interface then prompts the user to assign functionality to the icon. Upon completion of user input and activation of the icon, the new icon is effectively added to the same branch of the hierarchy from which the insertion icon 106 was selected to start the icon assignment and insertion process. For example, by reference to the hierarchy in FIG. 2, if the user selects Insert Icon 106 in branch 44, upon activation of the icon to be inserted, it will be added to branch 44 of the hierarchy. A user can therefore navigate down the hierarchy by selecting menu icons that reveal other icons until the desired branch of the hierarchy has been reached. Selecting an Insert Icon in that branch allows the insertion of a new icon in that branch. The result is the user-directed population of that branch of the hierarchy, initiated by the selection of the Insert Icon 106 from that branch.

Each organizational customer that accesses the content management system of the invention accesses that organization's own hierarchy of content, referred to herein as an “instance”. An instance therefore comprises the collection of icons created by and maintained by a given organizational customer as well as the actions and content that selecting each icon gives access to. In the nomenclature used in this description, a client N (not shown) is associated with an instance N. Each instance is characterized by the icon records contained in one of a plurality of instance-specific databases Client 30 DB, Client 32 DB, Client 34 DB . . . Client N DB (FIG. 1), by the content that certain of the icons are associated with (which content is saved in one of a plurality of instance-specific file repositories Client 30 FR, Client 32 FR, Client 34 FR . . . Client N FR), and by instance-specific user-customized presentation features that are also stored in the appropriate instance database and file repository.

Instance Access Control

Upon server 10 receiving a first request from a user for access to the system of the invention, Instance Access Control subsystem 14 queries the Instances Management Database 22 to identify the requested domain and to determine which organizational customer, and accordingly which instance, is associated with that domain. Having identified the intended instance, additional instance-specific information is retrieved from the Instances Management Database 22, including which Custom Modules 20 are to be enabled for that instance, the security protocol for communications with the devices 12 for that instance (e.g. SSL enablement) and certain other client information such as company name, account status and contact information.

Instance Access Control 14 also accesses the appropriate Client database (for example Client 32 DB for instance 32), to retrieve the GUI presentation specifications for the user interface that is specific to that instance, including the customized colours, sizes and file names of the visual features characterizing the banner and the user interface for that organizational customer. The file names point to files in the Client 32 FR file repository that are used to build the user interface for instance 32.

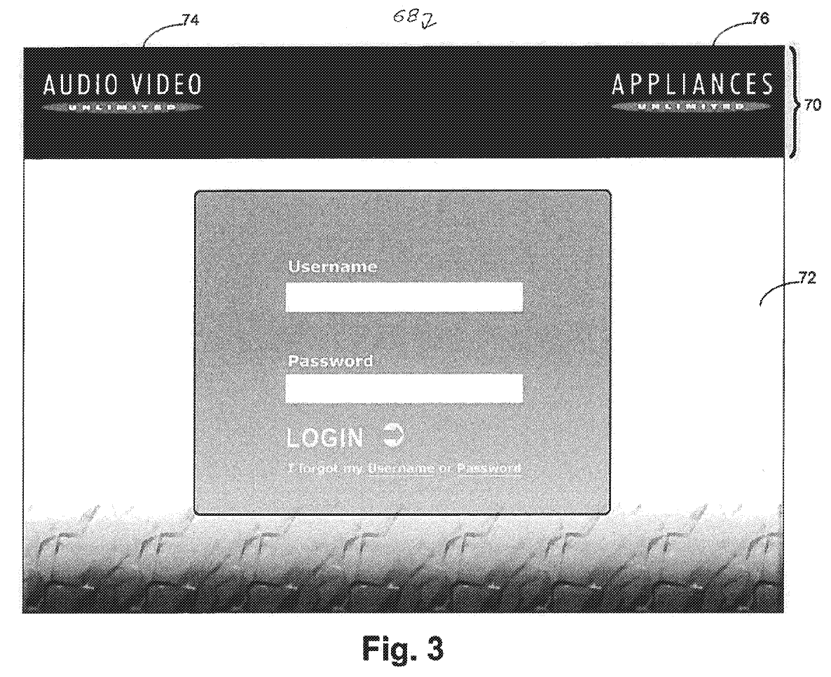

Instance Access Control subsystem 14 then serves a login user interface that is specific to that instance and is therefore customized for that organizational customer. An example of such a customer-specific login user interface 68 is illustrated in FIG. 3. For example, each page has a header 70 and a general background 72, as well as logos 74, 76, all customer-specified. Such customized user interface 68 is used consistently throughout the presentations of that instance to any users within an organizational customer.

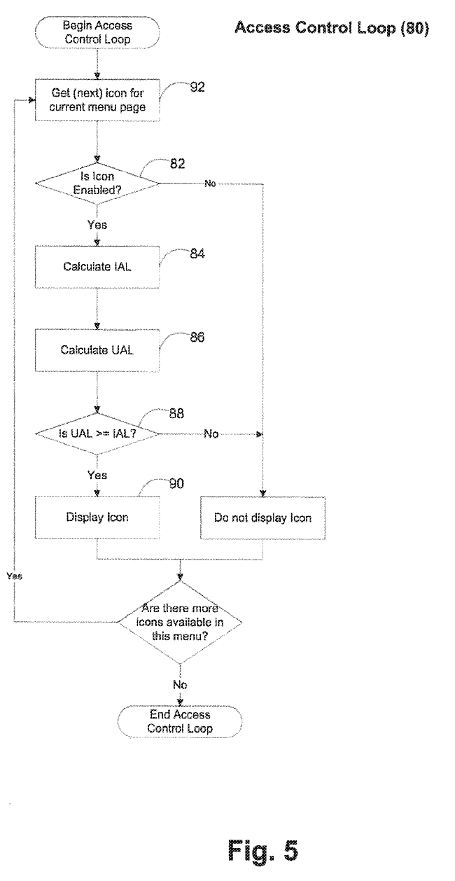

Upon user input into the login screen, the User Access Control subsystem 16 consults an employees or users record 213 (FIG. 6) that is maintained in the instance database 24 for the particular instance associated with the domain requested by the user. The employees or users record 213 records, among other things, the credentials of users authorized to access the content management system of the invention and in doing so it associates the user with the specific instance in question, including the hierarchy of icons and content that characterize that instance. The employees or users record 213 also records the access security level for each user of the system.

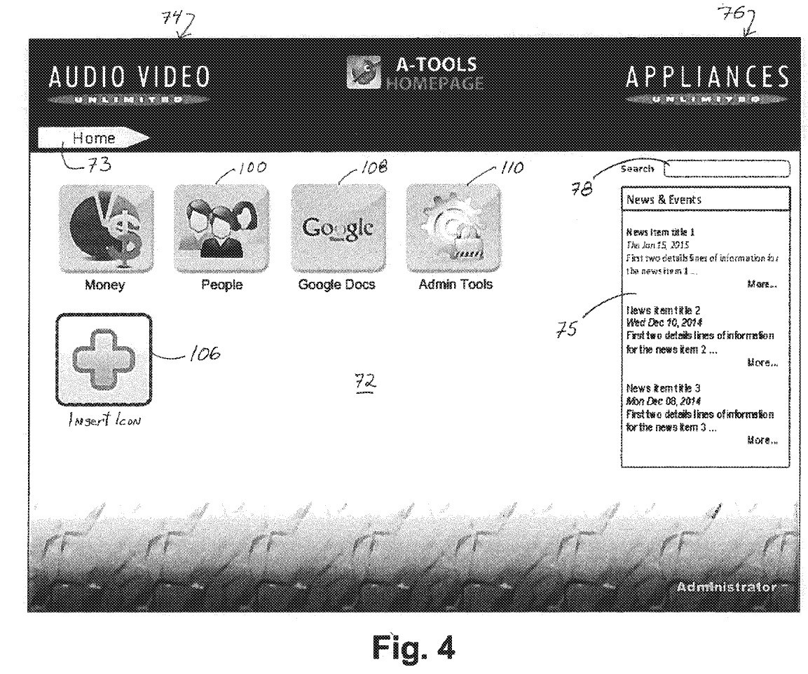

Upon successful login, the User Access Control subsystem 16 retrieves from the appropriate instance database, for example Client DB 32 for instance 32, the icons that make up the home page 77 for that instance and displays them with the presentation features that were customized for that instance, as illustrated in FIG. 4. However, any given user within an organizational customer may not have the authority to view all of such icons. The visibility to the user of each icon is controlled by the User Access Control subsystem 16.

User Access Control

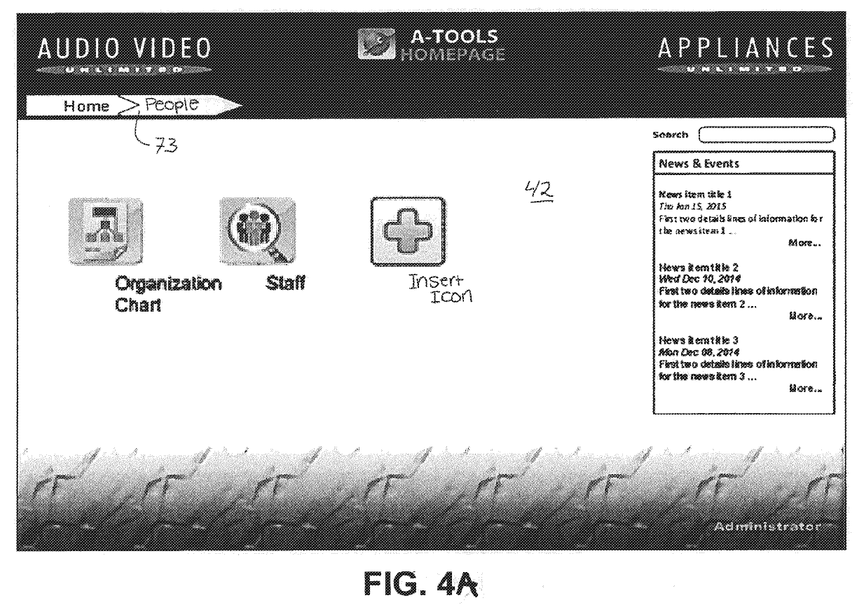

Upon receipt of login information from a particular user associated with an organizational customer, the User Access Control subsystem 16 undertakes an Access Control Loop 80 (FIG. 5) to determine which icons will be revealed to the user that is presently logged in. The decision is based on the access security levels of the icons in question, on the access security level associated with the given user and optionally on a group access security level assigned to the user's specific office within the organizational customer.

In the preferred embodiment, the instance databases 24 maintain records of the access security levels for users and for icons on a numerical scale (for example, 0-5), although the user interfaces may designate the security levels with non-numerical identifiers. In the preferred embodiment, the highest security level is “0”.

The Access Control Loop 80 determines (82) whether an icon under consideration for display is enabled. According to the preferred embodiment, an icon may be disabled so as to effectively render invisible any downstream branches of the hierarchy that depend from that icon. If an icon is disabled, it will not be displayed.

The instance database for a given customer, e.g. Client DB 32, contains an icon functionality record for each of the icons in the hierarchy, including those that make up the home page. Each icon functionality record (200 in FIG. 6) includes the icon access security level (for example, 0-5) associated with the icon, among other icon attributes relating to the functionality of the icon.

The Access Control Loop 80 evaluates (84) an icon access level (“IAL”) that is associated with each icon in the current branch of the hierarchy. According to the preferred embodiment, that is done by querying the icon functionality records 200 of the icon in question and of all other icons from which the icon in question depends in the hierarchy, to determine the highest icon access level among them. That highest level is used as the IAL for the icon under consideration for display in a given branch.

In order to determine the access security level of a user, the Access Control Loop 80 queries a user record for the given user, which user record is maintained in the appropriate instance database (e.g. Client 32 DB). The Access Control Loop 80 thereby determines the particular user's assigned user access security level, the office or location of the organizational customer with which the particular user is associated and the group access security level assigned to that office or location. The system then uses that information to determine (86) a User Access Level (“UAL”), which in the preferred embodiment is defined as the lower of the access security level of the user and the access security level of the user's office.

The decision whether to render visible and display a particular icon from the icons that make up any given display page/branch is made by determining (88) whether the UAL is greater than or equal to the IAL. If it is, the icon is displayed (90) to the user. The process is repeated (92) for each icon on a given page. As a result, a given icon will only be displayed to a given user if the user has a sufficient access security level compared to the access security level assigned to the icon at the time the icon was inserted into the hierarchy.

The same Access Control Loop 80 is engaged each time a user logs in to an instance in order to determine which icons on the home page will be displayed to the particular user, and each time the user selects a particular menu icon to determine which of the child icons that might be revealed by the menu icon should actually be made visible. Where an icon is visible to the user, the user has already been authorized to view that icon and the corresponding action or content associated with the icon is enabled directly upon user selection of the icon.

The particular icons that make up the home page 77 are identified by a value stored in a ParentID field 312 of the icon functionality record 200 that is maintained for each icon in the hierarchy. ParentID 312 refers to the icon's dependency from a specified menu icon. If the value of ParentID is 0, indicating that there is no parent menu icon from which it depends then it belongs on the home page. When it is not “0”, the ParentID field is populated with a unique icon identifier (IconID 300) of the menu icon from which it depends.

In one embodiment, public access to an instance may be provided by assigning a predetermined lowest level of security for public access. In such embodiment, a home page is served directly to any member of the public that requests the URL for that instance. Members of the general public are assumed to have the lowest security level. Accordingly, such home page will only display those icons that are permitted for that lowest security level, in accordance with the security protocols discussed above. The Access Control Loop 80 will determine which icons are to be made visible to the public access user based on the lowest security level that is assumed to apply to the public user. The home page may however include an optional login button to allow a user to call up a login interface so as to allow the user to identify himself or herself and to have the user's actual assigned security level be recognized for further navigation within the instance.

Navigation Through the Hierarchy

Icons are used to represent different types of content (e.g. a video or a document) or actions (e.g. launch an application or request a web page) or may be menu icons that open to reveal one or more child icons. All of such activities might be considered as icon-dependent action resulting from the selection of an icon. The use of a particular type of icons, designated herein as “menu icons”, is one of the features that enables the icon-centric development of a hierarchy of content and icons.

Navigation through the hierarchy of icons for a given instance is accomplished by selecting a menu icon (such as icon 100 in branch 38, see FIG. 2) which, in the preferred embodiment opens to entirely replace the previous set of icons with a display of the child icons. The structure of the overall hierarchy illustrated in FIG. 2 suggests that icons 102 (Organizational Chart), 104 (Staff), 106 (Insert Icon) would be revealed by selecting the menu icon 100 (People). FIG. 4A shows an interface display of a branch 42 of the hierarchy which has been revealed by selecting icon 100 in branch 38.

At each selection of a menu icon, the User Access Control subsystem evaluates the visibility to the given user of each icon in the depending branch by comparing the IAL and the UAL for that icon. As a result, the system of the invention provides a mechanism for selectively revealing icons based on access security levels associated with the individual icons on an icon by icon basis, and further based on an access security level associated with a particular user.

By drilling down through menu icons, the user navigates downward through that part of the hierarchy that is visible to that user to eventually reach a desired action icon or content icon. The user can navigate back upward through the hierarchy by selecting an icon from a footprints menu (73 in FIGS. 4 and 4A) that illustrates the user's path down the hierarchy.

Hierarchy Development

In the preferred embodiment, the complete hierarchy of icons is developed by a designated authorized user (for example an administrator) within an organizational customer and the modification of the hierarchy is preferably not enabled for all users. By allowing only the authorized user to establish or modify the hierarchy, the system of the invention can be used to compel, for example, a hierarchical structure that is in line with the preferred model of corporate information for a given customer. However it is within the scope of the invention for a particular embodiment to enable various users to participate in the creation and modification of the hierarchy. In the icon-centric system of the invention, the hierarchy is established by inserting icons into the hierarchy, notably menu icons that reveal child icons.

A hierarchy is established by the user through the steps of creating icons which are stored for eventual use (or alternatively relying on a library of icons made available by the system) and inserting icons in a given branch in the hierarchical tree. If an added icon is a menu icon, the menu icon may be opened, and other icons may be added within the branch representing the opened menu icon. This approach is enabled by providing (and rendering visible to authorized users) an insertion icon 106 on the home page and at each branch of the hierarchical tree that is opened by a menu icon. By navigating to such a branch, the insertion icon can be used to populate that branch with other icons, including with another menu icon. By then opening the menu icon, the system application 18 automatically includes an insertion icon in the branch to enable the user to then establish a child branch of the hierarchy by populating the branch with yet other icons.

Control over the right to establish or modify the hierarchy is enabled by rendering the insertion icons visible only to users having a sufficient high security access level.

It is to be noted that in the preferred embodiment, the insertion icon can be used interchangeably to either add a content or action icon, or add a menu icon that can be used to further develop the tree.

The system manages the assignment of functionality of the icons as part of the icon insertion process in which the user assigns a type to each icon and specifies the behavior of the icon. The visibility of the icon to users is also controlled at the time of icon assignment and insertion by the user specifying the access security level associated with the icon.

Types of Icons

According to the preferred embodiment, various types of icons are provided as follows:
1. A menu icon that may reveal a collection of child icons (partially described above).
2. A blog icon allowing the authorized user to post comments and attach multimedia content.
3. A clone icon that points to an existing blog icon and displays the same content but in a different location.
4. A file icon that opens a specific file.
5. A link icon comprising a web hyperlink.
6. An embed icon that opens a web page within the browser and user interface of the system of the invention.
7. An application icon that launches an application.

User-Directed Icon Design and Creation

As noted above, a new icon is created by opening an icon designated in the preferred embodiment as Icon Designer 112. Icon Designer 112 is placed at a conveniently accessible location in the hierarchy. In FIG. 2, it is located in branch 44.

Selecting the Icon Designer icon causes the server to prompt the user for the inputs needed to design an icon. The user may input a name 302 to be associated with the new icon for easy retrieval at a later date.

The user is prompted to select or upload a background for the new icon. A library of available backgrounds 132 for icons is maintained in a “global” file repository Gobal Icons 130 that is intended for access by all instances. Global Icons is maintained in the Instances Management Database 28. The backgrounds in question may be of a predetermined size and shape conforming to a preferred form factor for icons displayed by the system of the invention.

The user is also given the option of uploading a background from another source. The system application 18 detects the size of the background uploaded by the user. In the event that the uploaded background is not of the predetermined size, the system application 18 automatically resizes the oversized or undersized background to the predetermined size.

The user is also prompted to select a foreground image to be applied over the background. The image may be selected from the repository of available images 134 stored in Global Icons 130, or an image may be uploaded by the user.

Where a user elects to upload an image intended to be superimposed over a background, the system application 18 verifies the image file type and authorizes use of only predetermined image file types. According to the preferred embodiment, only .png and .gif files are authorized as each of such file types allows certain pixels to be coded as transparent thereby allowing the background to be visible around a core element of the image.

The system overlays the image on the background and displays it to the user. The user may position and resize the image on the background by means of handles. Upon receiving a user input that the icon design is complete, the completed icon image is stored in the file repository that is specific to the instance, e.g. Client 32 FR. User-created icons are identified in Client 32 DB as instance icons, and their corresponding images are stored in Client 32 FR. If the user used a background or a foreground from Global Icons 130, those are already separately stored. If there were supplied by the user, the background and foreground are saved separately in Client 32 FR.

Client 32 DB maintains an icon creation record 202 for each icon created by users for a given instance. The icon creation record 202 contains information about the design of the icon itself. The icon creation record stores the locations of the image of the overall icon, the background component and the foreground portion of the icon.

When a user wishes to edit a previously designed icon, the system application 18 queries the icon creation record 202 to locate and retrieve the background and the foreground comprising a particular icon, overlays them and presents them to the user for editing.

Insertion and Use of Icons

In order to introduce a new icon to the hierarchy, the authorized user navigates to the branch in which the icon is to be introduced. As indicated above, the system application 18 populates each branch with an insertion icon (Insert Icon 106), which is made visible only to users authorized to modify the hierarchy.

Upon user selection of the insertion icon, the server presents a user interface prompting the user to assign a type to the icon to be inserted. According to the preferred embodiment as described above the type options are menu icon, link icon, application icon, blog icon, clone icon, file icon and embed icon.

The specific icon graphic to be used is selected from the user-created instance icons that are stored in Client 32 FR or alternatively from a library 130 of predetermined icons made available to all instances.

According to the type of icon, additional user-directed parameters may be required to provide the necessary functionality to the desired type of icon.

In the case of an application icon, the user provides inputs for a standard hyperlink URL 308 that normally engages a particular application when the icon is selected. However the user also specifies an alternative URL 309 to engage a different application when users of a predetermined user access security level select the icon. In each case, the icon functionality record 200 is populated with the standard URL 308, and if applicable also the alternative URL 309. An example of an application icon is the icon Google Docs 108 in FIGS. 2 and 4.

In the case of a file icon, an upload prompt allows the user to upload a file to be accessed by later selection of the icon.

In the case of a link icon, the user inputs the URL for the link and indicates whether the linked page is to open in the same window or in a new browser window.

In the case of an embed icon, the user specifies the screen width to be used with the page display along with a URL for a link page to be embedded in the GUI of the system and indicates whether the linked page is to open in the same or in a new browser window.

In the case of a done icon, the user specifies the blog icon to be cloned.

Regardless of the type of icon, the icon insertion process includes receiving from the user an icon access security level 306 to be associated with the icon. The icon access security level (in conjunction with the user access security level) determines which users have access to the icon and therefore whether the icon will be made visible to a given user. The icon access security level associated with the icon is stored in the icon functionality record in Client 32 DB for reference when executing the Access Control Loop during user interactions.

The icon functionality record 200 contains information detailing all of the functionality of an icon and is populated upon the user specifying the icon functionality as part of the icon insertion process.

Control over access to the icon may further include the user who is inserting the icon selecting an option that limits the right of others to edit the particular icon, even if it is visible to a given level of user. This is also done by selecting a security level for icon editing purposes.

File Repositories, Databases, Records

The system of the invention, including the management of instances, is enabled by providing an Instances Management Database, a plurality of Instance Databases and a plurality of Instance File Repositories.

The structure of the Instance File Repositories of the preferred embodiment is illustrated in FIG. 9. Each client instance (Instance 30, Instance 32 . . . Instance N) has its own file repository that includes the icons 150 for that instance, the GUI presentation features 152 specific to that instance and content files for that instance. In order to enable a user to edit one of the user-created instance icons, the background 154 and the foreground 156 images that make up the icon are also stored in the Icons folder 150, unless the particular icon comprises images drawn from the Global Icons repository 130, in which case the icon creation record 202 simply points to the source of the background and foreground images.

The GUI presentation features 152 comprise the backgrounds, text, logos and other images that make up the user-customized look of the page. This may include a banner portion 70, the overall background 72 behind the icons, the size and position of ancillary features such as a news feed 75, a search button 78 and other features of the user interface.

Content items are stored in separate files according to the medium involved, such as Audio files 124, Document files 126, Video files and Other Images 129.

The databases that support the invention comprise on the one hand an Instances Management Database 22 and on the other hand a plurality of Instances Databases (Client 30 DB, Client 32 DB, etc.).

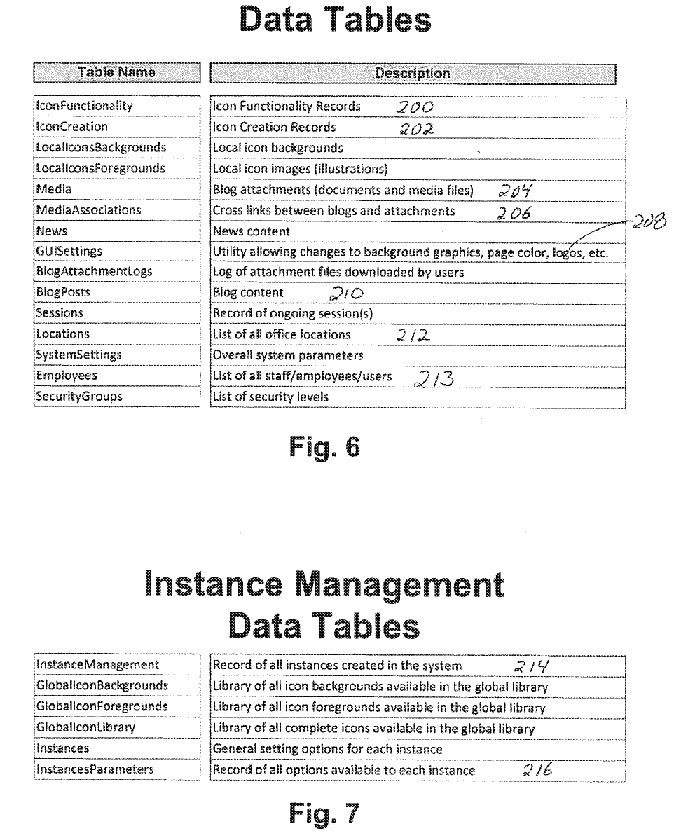

Referring to FIG. 7, the Instances Management Database includes a number of tables that are used to manage the plurality of instances that may be available through the preferred embodiment. An InstanceManagement table 214 records the domains associated with each customer instance along with a reference ID to the specific instance database 24 that applies to that instance.

An InstancesParameters table 216 records, among other things, what modules are allowed for a given instance.

Each instance database 24 comprises a number of tables and records enabling the operation of a given instance, including those illustrated in FIG. 6.

An IconCreation table comprises the icon creation records 202 for each icon created by a user within the context of a given instance. The icon creation record 202 of the preferred embodiment comprises the icon ID (IconID 300), the icon image location 320, the background location 322, the foreground image location 324, and which user created the icon (CreatorID 318).

An IconFunctionality table comprises the icon functionality records 200 for each icon used by that instance. The icon functionality record 200 according to the preferred embodiment comprises all of the fields needed to enable the icon, including:
type of icon 304
icon image ID 314
icon name 302
parent Icon ID 312
icon access security level 306
attachment name/location 310
referral ID (316)
URL 308
URL (alternate for certain authorized users) 309
flag to open in new window 315
flag to enable/disable 305

Use of Records and Type Management

When the user selects an icon for display, the system queries its type as a value stored in the icon functionality record 200 in the particular instance database. Depending on the type of icon indicated, an appropriate process for icon handling is invoked.

As discussed above, menu icons are used to drill down into the branches of the hierarchy. A footprints feature (73 in FIG. 4) displays the path taken to the current page and may be used to backtrack up the hierarchy. The parent-child relationship between the menu and child icons is recorded in a “ParentID” field 312 in the icon functionality record 200. The ParentID field 312 identifies the menu icon from which the given icon depends. A “0” value indicates that the menu belongs on the home page. When an icon is selected by a user, the system application 18 identifies the icon type by reference to the type 304 recorded in the icon functionality record 200. If the type is a menu icon, a menu icon process is invoked and executes to identify the child icons that will populate the new page. That is done by querying the ParentID fields in the icon functionality records for all the icons in that instance. The same process is invoked to populate the home page with icons by identifying all icons for which the ParentID is 0.

A blog icon (such as the “Birthdays” icon 116 in FIG. 2) generates a blog-like page that collects one or more posts from a user and presents them in a predetermined order (for example, the most recent post is displayed at the top). The posts of a blog icon are stored in a table of posts 210, each post being associated with a particular blog icon. Documents and multimedia files may be attached to the blog and links may be provided. According to the preferred embodiment, a post may be enabled to display indefinitely or may have an expiry date at which time it will no longer be displayed.

When a blog icon is selected, a blog icon process is invoked by the system application 18 to query the posts table 210 for those posts associated with the selected blog icon and to display them to the user in a suitable format.

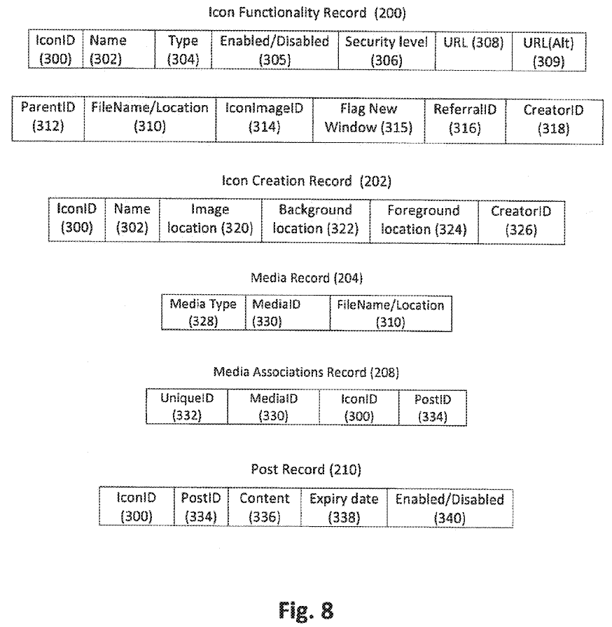

Each new post to a blog generates a record in the table of posts 210. Each post record 210 includes the IconID 300 of the blog icon to whose blog the post is made, a PostID 334, the content 336 of the post and additional information such as the expiry date 338 of the post and whether it is enabled or disabled (340). Any attachments associated to the post are saved to the file repository for that instance (for example, in audio files 124 in FIG. 8), while a record of the attachment is saved in a Media table 204. The record for each attachment includes the type of media 328, a unique media ID 330 for the item and a file name 310 (enabling its retrieval from the file repository). A Media Associations table 206 records the association between a given attachment file and a post by recording a unique ID 332, a media ID 330, the blog's IconID 300 and a PostID 334, enabling the association of a particular attachment to a particular post for the blog enabled by the particular blog icon.

Once invoked, the blog icon process queries the blog posts table 210 to identify all post records that include the IconID 300 for the given blog icon and for which the post is not expired or disabled. For each relevant post, the process also queries the Media Associations table for any media file records that include the PostID 334 for that post. The blog icon process sorts the posts for display in chronological order or in another order selected by the user who inserted the blog icon into the hierarchy.

A clone icon is used to clone the content of a blog icon that is usually located elsewhere in the hierarchy. An example of a clone icon is the Birthdays icon 118 in FIG. 2, cloned from Birthdays 116. The clone icon may be located anywhere in the hierarchy but provides the same display, attachments and links as the parent icon from which it is a done. When a clone icon is selected, a clone icon process is invoked and executes to query the referral ID (ReferralID 316) of the clone icon's icon functionality record 200. The ReferralID 316 provides the IconID of the blog icon whose content is to be cloned into the display. The blog icon process then retrieves the post and any attachments in the same manner as described above but by using the IconID of the referred blog icon in the post and attachments retrieval process. Because the clone icon is typically at a different location in the hierarchy, the footprints display 121 that tracks the path to the clone icon is not changed to that of the referred icon and it continues to display the path to the done icon itself.

A file icon is used to open a multimedia file directly. The file icon process retrieves the FileName/Location 310 from the icon functionality record 200. FileName/Iocation 310 points to the specific file to be opened, which is located in the files segment 125 of the instance file repository Client 32 FR.

A link icon is used to open a web page. The link icon process retrieves the URL 308 from the icon functionality record 200, requests the web page and displays it to the user.

An embed icon is used to provide a link to a web page but which opens within the presentation framework (using the same window and header) for the given instance. The embed icon process retrieves the URL 308 from the icon functionality record 200, requests the web page and controls the presentation of the page within the instance presentation framework.

An application icon acts to launch an application specified by a URL 308 in the icon functionality record 200.

A Media and a Media Associations tables record the specific content items that have been associated with an instance and which icons they are associated with, as discussed above.

A GUI Presentation table records the elements that make up the customized GUI presentation, notably the header, used in the user interface for the instance.

A BlogPosts table contains the posts that have been made to blog icons in a given instance. The table associates the individual posts with specific blog icons.

A Locations table 212 lists the various locations of an organizational customer using an instance and includes an indication of the group access security level assigned to a particular location. Such group access security level is used in determining the UAL as part of the Access Control Loop process described above.

Presentation Tools

In the preferred embodiment, the top portion of the page contains the header 70. The header 70 includes a customizable area to display identifying information for the user's organization, including one or more logos 74, 76. The header also displays a footprints button 73 among other features that are not show in the drawings, such as a logout button, the name of the current user, etc. In the preferred embodiment, the header further includes a search bar, and the side of the page has a news feed and notification of reminders.

Other customizable aspects of the graphical user interface include the overall page background 72 and imagery on parts of the page other than the header 70.

The customization of such features is directed by an authorized user by providing a GUI customization icon (User Interface 114) having an icon access security level corresponding to the user access security level of the authorized user and therefore that will be visible only to such authorized users.

The Instance Database Client 32 DB comprises a record (GUI settings 208) of the user-specified backgrounds, logos and images and their locations in the banner portion of the interface. The corresponding files are maintained in the GUI content 152 section of the file repository for the instance in question.

In the foregoing description, exemplary modes for carrying out the invention in terms of examples have been described. However, the scope of the claims should not be limited by those examples, but should be given the broadest interpretation consistent with the description as a whole. The specification and drawings are, accordingly, to be regarded in an illustrative rather than a restrictive sense.

1. A method of delivering enterprise content for display on a client device, comprising:
maintaining, at a database and a file repository associated with a server, records and files that represent a tree-based hierarchy of icons, said hierarchy comprising a plurality of branches;
each of said icons being associated with one of a plurality of icon-dependent actions;
enabling remote access to said icons by:
causing a remote user to navigate said hierarchy by selecting an icon in a given branch;
said server or a system application associated with said server executing an action responsive to said user selection of an icon;
at least one of said icons being a menu icon that, when selected by a user, reveals one or more other icons at a lower branch of said hierarchy;
at least one of said icons being a content icon that, when selected by a user, causes the display of a document on said remote device or the running of an audio or a video file for delivery to said remote device;
at least one of said icons, when selected by a user, causes either the launch of an application or the display of a web page identified by a hyperlink;
displaying to an authorized user on said device an icon that, when selected by a user, causes the server to display on said remote device an interface enabling said authorized user to create and design a new icon;
saving an image of said new icon in said file repository and recording features of said icon in said database;
displaying to an authorized user on said device an icon (“insertion icon”) on each branch of said hierarchy, that when said insertion icon is selected by a user, causes the server to display on said remote device an interface enabling said authorized user to assign functionality to a pre-existing icon and to insert said pre-existing icon with said user-assigned functionality in the branch from which said insertion icon was selected.

2. A method of delivering enterprise content for display on a remote client device, comprising:
maintaining, at a database and a file repository associated with a server, records and files that represent a plurality of icons in a tree-based hierarchy of icons, said hierarchy comprising a plurality of branches;
each of said icons, when selected by a user, causing one of a plurality of icon-dependent actions to occur on said remote device and
at least a first one of said icons (“menu icon”), when selected by a user, revealing one or more other icons at a lower branch of said hierarchy;
at least a second one of said icons (“content icon”), when selected by a user, displaying a document or running an audio file or a video file;
at least a third one of said icons, when selected by a user, executing an action from among the group of actions comprising launching an application, opening a blog, displaying a linked web page;
providing to an authorized user one or more interfaces for enabling the authorized user to:
create and design said icons; and,
populate said hierarchy with said icons.

3. The method of claim 2 wherein a first predetermined icon (“designer icon”) is displayed to an authorized user, said designer icon, when selected by said authorized user causes said server to provide an interface enabling said authorized user to create and design a new icon.

4. The method of claim 2 wherein a second predetermined icon (“insertion icon”) is displayed to an authorized user at each branch of said hierarchy, said insertion icon, when selected by said user from any of said branches, causes said server to provide an interface enabling said user to select a previously created icon and to assign functionality to said previously created icon, and wherein said server or said system application inserts said previously created icon having said assigned functionality into said branch from which said second predetermined icon was selected.

5. The method of claim 3 wherein a second predetermined icon (“insertion icon”) is displayed to said authorized user at each branch of said hierarchy, said insertion icon, when selected by said authorized user from any of said branches, causes said server to serve to said remote device an interface enabling said authorized user to select a previously created icon and to assign functionality to said previously created icon, and wherein said server or said system application inserts said previously created icon having said assigned functionality into said branch from which said insertion icon was selected.

6. The method of claim 3 wherein:
said interface prompts said authorized user to identify a background for an icon to be created;
said interface prompts said authorized user to identify a foreground image to be overlaid on said background;
said server or said system application overlays said foreground image on said background, saves the resulting image in a file repository and records the sources for said background and said foreground image.

7. The method of claim 6 wherein said interface enables said authorized user to position said foreground image in relation to said background and to resize said foreground image.

8. The method of claim 6 wherein said file repository comprises a plurality of pre-existing backgrounds and foreground images for selection by said authorized user and said interface provides to said authorized user the alternative option of uploading background or foreground images from external sources.

9. The method of claim 4 wherein said user assigning functionality to said previously created icon comprises the steps of:
selecting, from a list of options in said interface, a type of action that is to result from user selection of said previously created icon in said hierarchy;
specifying a specific action that is to result from user selection of said previously created icon in said hierarchy; and,
specifying an access security level to be associated with said previously created icon.

10. The method of claim 4 wherein said server displays said insertion icon only to authorized users having a predetermined access security level.

11. The method of claim 6, said records comprising a first icon record (“icon design record”) for each icon created by an authorized user, said icon design record containing:
the location in said file repository of said background;
the location in said file repository of said foreground image; and,
an icon ID
and further comprising a second icon record (“icon functionality record”) for each icon in said hierarchy, said icon functionality record containing data characterizing an action to be executed upon user selection of the icon to which said icon functionality record relates.

12. The method of claim 2 wherein said records comprise:
an icon functionality record for each icon in said hierarchy, said icon functionality record specifying an icon access security level associated with each icon;
a user record for each user, said user record specifying a user access security level;
and wherein each time a menu icon is selected by a user, comparing said user access security level to said icon access security level and only displaying those icons for which the icon access security level is equal or lower than the user access security level.

13. The method of claim 2 wherein:
each icon is associated with an icon functionality record comprising a first field indicative of whether said each icon is of a type that reveals other icons when selected by a user, and a second field identifying, if applicable, a menu icon from which said each icon depends, and
upon a user selecting any particular icon in said hierarchy, said system application determining whether said icon is of a type that reveals other icons and if so, polling all icons in said hierarchy to identify those icons for whom said second field identifies said particular icon.

14. The method of claim 2 wherein said database comprises:
for each icon in said hierarchy:
an icon design record; and
an icon functionality record, said icon functionality record comprising an icon access security level associated with said icon;
for each of a plurality of users, a user record associating each user with a user access security level;
and wherein, before displaying any particular icon to a given user, the icon access security level for the particular icon is compared to the given user's user access security level, and only those icons are displayed that have an icon access security level equal to or lower than the user access security level associated with the given user.

15. The method of claim 14 wherein the action that is executed upon the selection of an icon by a particular user is a function of the user access security level associated with said particular user.

16. The method of claim 2 wherein at least one of said icons, when selected by a user, opens a copy of a blog that can also be opened by another icon at another branch of said hierarchy.

17. The method of claim 9 wherein specifying a specific action comprises specifying a pre-existing icon that causes a blog to open such that a copy of that blog will be opened.

18. A method of delivering enterprise content for display on a remote client device, comprising:
maintaining, at one or more databases and one or more file repositories associated with a server, records and files that represent a first plurality of icons in a first tree-based hierarchy of icons (“first hierarchy”), and a second plurality of icons in a second tree-based hierarchy of icons (“second hierarchy”), each of said first hierarchy and said second hierarchy comprising a plurality of branches;
maintaining at said one or more databases a user record for each of a plurality of users, said user record containing an association of said user with one of said first or second hierarchies;
providing access for a given user to the icons in said first or in said second hierarchy as a function of said association in said given user's user record;
each of said icons, when selected by said given user, causing one of a plurality of icon-dependent actions to occur on a remote device associated with said given user and
at least a first one of said icons (“menu icon”), when selected by said given user, revealing one or more other icons at a lower branch of the hierarchy identified in said given user's user record;
is at least a second one of said icons (“content icon”), when selected by a user, displaying a document or running an audio file or a video file;
at least a third one of said icons, when selected by a user, executing an action from among the group of actions comprising launching an application, opening a blog, displaying a linked web page;
providing to an authorized user one or more interfaces for enabling the user to:
create and design said icons; and,
populate said icons into the hierarchy with which said authorized user is associated in said user record.

19. The method of claim 18 wherein said databases comprise an instances management database containing an association of domain names with each of said first and second hierarchies.

20. The method of claim 18 where said files comprise a library of icon backgrounds and icon foregrounds accessible to users associated with said first hierarchy and to users associated with said second hierarchy, and said files comprise records of icon backgrounds and foregrounds associated with said first hierarchy, said method comprising the step of revealing to a user associated with said first hierarchy only those icons associated with said first hierarchy.

21. The method of claim 18 wherein said records comprise icon creation records each recording a unique icon identifier and the combination of background and foreground that comprise each icon, said records further comprise icon functionality records each determining the behavior of a given icon, said file repositories comprising a first file repository associated with said first hierarchy stores images of icons associated with said first hierarchy and a second file repository associated with said second hierarchy stores images of icons associated with said second hierarchy.
